(19) United States
(12) Patent Application Publication
(10) Pub. No.: US 2022/0180234 A1
(43) Pub. Date: Jun. 9, 2022

(54) SYSTEMS AND METHODS FOR SYNTHETIC DATA GENERATION USING COPULA FLOWS

(71) Applicant: JPMORGAN CHASE BANK, N.A., New York, NY (US)

(72) Inventors: Sanket KAMTHE, London (GB); Samuel Ayalew ASSEFA, Hoboken, NJ (US); Prashant P REDDY, Madison, NJ (US); Maria VELOSO, New York, NY (US)

(21) Appl. No.: 17/456,710

(22) Filed: Nov. 29, 2021

Related U.S. Application Data
(60) Provisional application No. 63/121,100, filed on Dec. 3, 2020.

(51) Int. Cl. G06N 7/00; G06F 16/25

(52) U.S. Cl. CPC G06N 7/005; G06F 21/6245; G06F 16/258

(57) ABSTRACT

Systems and methods for generating synthetic data using a learned copula are disclosed. In accordance with embodiments, a method for generating synthetic data may include receiving a true dataset that includes continuous data and discrete data; applying, to the continuous data, a probability integral transform and performing an independent uniform marginal; applying, to the discrete data, a distributional transform and performing an independent uniform marginal; applying a copula learner to learn a copula from the transformed continuous data and the transformed discrete data; identifying a correlated uniform marginal from the learned copula based on the transformed continuous data; identifying a correlated uniform marginal from the learned copula based on the transformed discrete data; applying continuous inverse transform sampling and a discrete inverse transform sampling on the respective correlated uniform marginals and generating synthetic data using the continuous inverse transform sampling and the discrete inverse transform sampling.

### RELATED APPLICATIONS

This application claims priority to, and the benefit of, U.S. Provisional Patent Application Ser. No. 63/121,100, filed Dec. 3, 2020, the disclosure of which is hereby incorporated by reference in its entirety.

### BACKGROUND

### 1. Field of the Invention

Embodiments are generally related to systems and methods for synthetic data generation using copula flows.

### 2. Description of the Related Art

The generation of synthetic data for testing systems and computer programs is complex, especially in view of privacy concerns. To be effective, the synthetic data should bear a relationship with real-world data, and it also should not allow reverse engineering to identify a real-world individual. Typical synthetic data generation may generate data that is similar to true data, but it may miss certain relationships among variables.

The ability to generate high-fidelity synthetic data is crucial when available (real) data is limited or where privacy and data protection standards allow only for limited use of the given data, e.g., in medical and financial datasets. Some methods for synthetic data generation are based on generative models, such as Generative Adversarial Networks (GANs). Even though GANs have achieved results in synthetic data generation, they are often challenging to interpret. Furthermore, GAN-based methods can suffer when used with mixed real and categorical variables. Moreover, loss function (discriminator loss) design itself is problem specific, i.e., the generative model may not be useful for tasks it was not explicitly trained for.

### SUMMARY OF THE INVENTION

In some aspects, the techniques described herein relate to a method for generating synthetic data using a learned copula function, including: receiving a true dataset on which to model synthetic data, wherein the true data includes continuous true data and discrete true data; applying, to the continuous true data, a probability integral transform and performing an independent uniform marginal; applying, to the discrete true data, a distributional transform and performing an independent uniform marginal; applying a copula learner to learn a copula from the transformed continuous true data and the transformed discrete true data; identifying a first correlated uniform marginal from the learned copula based on the transformed continuous true data; identifying a second correlated uniform marginal from the learned copula based on the transformed discrete true data; applying continuous inverse transform sampling on the first correlated uniform marginal; applying discrete inverse transform sampling on the second correlated uniform marginal; and generating the synthetic data using the continuous inverse transform sampling and the discrete inverse transform sampling.

In some aspects, the techniques described herein relate to a method, further including: using a normalizing flow to learn the copula function.

In some aspects, the techniques described herein relate to a method, further including: using an autoregressive density network with the normalizing flow.

In some aspects, the techniques described herein relate to a method, wherein the autoregressive density network includes a masked autoregressive network.

In some aspects, the techniques described herein relate to a method, further including: learning a functional relationship within the continuous true data.

In some aspects, the techniques described herein relate to a method for generating synthetic data using a learned copula function, including: receiving true data on which to model synthetic data, wherein the true data includes discrete true data; applying a distributional transform and performing an independent uniform marginal; applying a copula learner to learn a copula from the transformed discrete true data; identifying a correlated uniform marginal from the learned copula; applying discrete inverse transform sampling on the correlated uniform marginal; and generating the synthetic data using the discrete inverse transform sampling.

In some aspects, the techniques described herein relate to a method, further including: using a normalizing flow to learn the copula function.

In some aspects, the techniques described herein relate to a method, further including: using an autoregressive density network with the normalizing flow.

In some aspects, the techniques described herein relate to a method, wherein the autoregressive density network includes a masked autoregressive network.

In some aspects, the techniques described herein relate to a method for generating synthetic data using a learned copula function, including: receiving a true dataset on which to model synthetic data, wherein the true data includes continuous true data; applying a probability integral transform and performing an independent uniform marginal; applying a copula learner to learn a copula from the transformed continuous true data; identifying a correlated uniform marginal from the learned copula; applying continuous inverse transform sampling on the correlated uniform marginal; and generating the synthetic data using the continuous inverse transform sampling.

In some aspects, the techniques described herein relate to a method, further including: using a normalizing flow to learn the copula function.

In some aspects, the techniques described herein relate to a method, further including: using an autoregressive density network with the normalizing flow.

In some aspects, the techniques described herein relate to a method, wherein the autoregressive density network includes a masked autoregressive network.

In some aspects, the techniques described herein relate to a method, further including: learning a functional relationship within the continuous true data.

### BRIEF DESCRIPTION OF THE DRAWINGS

FIG. 1 depicts a copula flow for learning distributions for true data, in accordance with embodiments.

FIG. 2 depicts a flow for generating synthetic data based on a learned copula, in accordance with embodiments.

FIG. 3 depicts a flow for generating synthetic data from continuous true data using a learned copula, in accordance with embodiments.

FIG. 4 depicts a flow for generating synthetic data from discrete true data using a learned copula, in accordance with embodiments.

FIG. 5A illustrates a plot of a probability integral transform, in accordance with embodiments.

FIG. 5B illustrates a quantile transform, in accordance with embodiments.

FIG. 6 illustrates discrete marginal flow, in accordance with embodiments.

FIG. 7 depicts a copula flow generative model, in accordance with embodiments.

### DETAILED DESCRIPTION OF EMBODIMENTS

Embodiments are generally related to systems and methods for synthetic data generation using copula flows. For example, embodiments may use a probabilistic model based on copula flows as a synthetic data generator. A probabilistic synthetic data generator may be interpretable and may model arbitrarily complex datasets. Embodiments may be based on normalizing flows to estimate copulas. This model is flexible enough to learn complex relationships and does not rely on explicit learning of the graph or parametric bivariate copulas.

Methods for learning a copula function are disclosed. In embodiments, normalizing flows may be used to learn a copula function, and an autoregressive density network for learning the normalizing flow. An example of an autoregressive density network includes a masked autoregressive network. In embodiments, any functional relationship in the true data may be learned by the network. Additionally, methods to learn discrete variables for a copula model are disclosed. A distributional transform may be used to map discrete variables to the corresponding random variables. The map may be learned using normalizing flows. In embodiments, synthetic data may be generated. For example, normalizing flow networks may be combined to generate synthetic data.

In accordance with embodiments, a modified spline flow as a continuous relaxation of discrete probability mass functions may be used to process count data. This formulation allows for building complex multivariate models with mixed data types that can learn copula-based flow models, which can, in turn, be used for: 1) Synthetic data generation: i.e., using the estimated model to generate new datasets that have a distribution similar to the training set. 2) Inferential statistics: once the copula has learned the relationship between the variables correctly, the marginals may be changed to study the effects of such a change. For example, if it is estimated a copula flow based on a dataset including resident individuals of the United Kingdom (“UK”) including age as one of the variables, the marginal of the age distribution may be modified to generate synthetic data for a different country. In this scenario, to generate synthetic data representing, e.g., resident individuals of Germany, Germany's age distribution may be used as a marginal for the data-generating process. 3) Privacy preservation: data generated from the copula flow model is fully synthetic, i.e., the generator does not rely on actual observations for generating new data. Generated data may be perturbed based on differential privacy mechanisms to prevent privacy attacks based on a large number of identical queries.

In accordance with embodiments, the domain of a function F by dom(F) and range by ran(F) may be denoted. Capital letters X, Y may be used to denote random variables and lower-case x, y may be used to represent their realizations. Bold symbols X=[X₁, . . . , X_{d}] and corresponding x=x₁, . . . , x_{d} may represent vectors of random variables and their realizations, respectively. The distribution function (also known as the Cumulative Distribution Function (CDF)) of a random variable X by F_{X}, and the corresponding Probability Density Function (PDF) by f_{X}, may be denoted.

In accordance with embodiments, if a random variable is mapped through its own distribution function the result is a uniformly distributed random variable-Uniform [0, 1] or uniform marginal. This is known as probability integral transform, and this definition holds for continuous variables. Accordingly, a copula may be considered a relationship, i.e., a link, between uniform marginals obtained via the probability integral transform. Two random variables are independent if the joint copula of their uniform marginals is independent. Conversely, random variables are linked via their copulas.

In accordance with embodiments, a pair of random variables, the marginal CDFs F_{X}, F_{Y}, may describe how each variable is individually distributed. The joint CDF_{X, Y} may describe how they are jointly distributed. The joint CDF may be written as a function of the univariate marginals F_{X} and F_{Y}, i.e.,

$${F}_{X , Y} ( X , Y ) = C ( {U}_{X} , {U}_{Y} ) = C ( {F}_{X} ( X ) , {F}_{Y} ( Y ) ) , \qquad$$

where C is a copula. Here, the uniform marginals are obtained by the probability integral transform, i.e., U_{X}=F_{X}(X) and U_{Y}=F_{Y}(Y).

Copulas may describe the dependence structure independent of the marginal distribution, which may be exploited for synthetic data generation; especially in privacy preservation, where data samples may be perturbed by another random process, e.g., the Laplacian mechanism. This may change the marginal distribution but, crucially, it does not alter the copula of the original data.

In accordance with embodiments, for continuous marginals F_{X} and F_{Y}, the copula C is unique, whereas for discrete marginals it is unique only on ran(F_{X})×ran (F_{Y}). Accordingly, it may be stated that X and Y are independent if and only if their copula is an independent copula, i.e., C(F_{X}(X), F_{Y}(Y))=F_{X}(X) F_{Y}(Y).

With respect to building a generative model, the inverse of the probability integral transform, called inverse transform sampling, allows generation of random samples starting from a uniform distribution. The procedure to generate a random sample x distributed as F_{X} may include first sampling a random variable u˜Uniform [0, 1] and second setting x:=F_{X}⁽⁻¹⁾ (u). Here, the function F⁽⁻¹⁾ is a quasi-inverse function.

In accordance with embodiments, a definition of Quasi-inverse function may be as follows:

$$Let F be a CDF . Then the function {F}^{( - 1 )} is a quasi \text{-} inverse function$$

$$of F with domain [ 0 , 1 ] such that F ( {F}^{( - 1 )} ( y ) ) = y ∀ y ∈ ran ( F ) and$$

$${F}^{( - 1 )} ( y ) = inf \{ x \vert F ( x ) \geq y \} ∀ x ∈ dom ( F ) , and y ∉ ran ( F ) . For strictly$$

$$monotonically increasing F , the quasi \text{-} inverse becomes the regular$$

$$inverse CDF {F}^{- 1} .$$

The inverse function, also known as the quantile function, maps a random variable from a uniform distribution to F-distributed random variables, i.e., X=F⁻¹(U) or F⁻¹: Uniform [0, 1]→ran(F). In light of this, the problem of synthetic data generation may be presented as the problem of estimating the (quasi)-inverse function for the given data. This quasi-inverse function definition may be used as a distributional transform for discrete data.

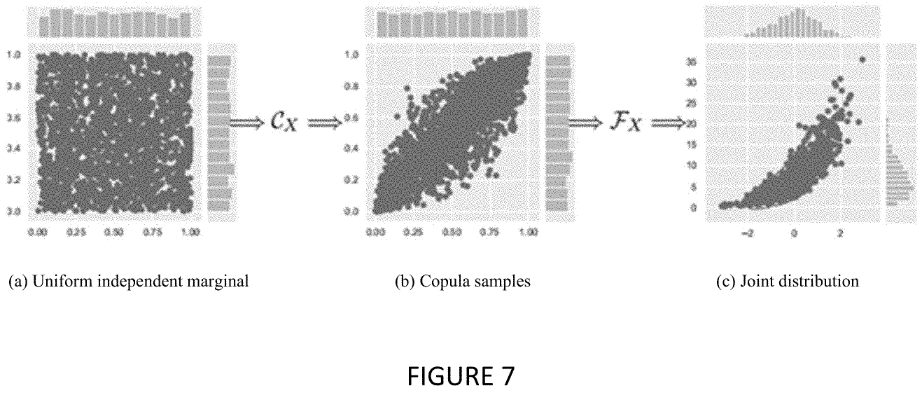

To generate samples from F_{X} using a copula-based model, a pair of uniformly distributed random variables may be passed through the inverse of the copula CDF to obtain correlated uniform marginals; see FIG. 7, chart (a). Note that the copulas are defined over uniform marginals, i.e., the random variables are uniformly distributed. The correlated univariate marginals may be used to subsequently generate F-distributed random variables via inverse transform sampling; see FIG. 7 chart (c). Thus, if the CDFs can be learned for the copula as well as the marginals, we can then combine these two models to generate correlated random samples that are distributed similar to the training data. This procedure is illustrated in FIG. 7.

FIG. 7 depicts a copula flow generative model, in accordance with embodiments. The leftmost chart of FIG. 7 (i.e., labeled “(a) Uniform independent marginal”) depicts uniformly distributed independent variable samples. These samples are passed through the copula flow network to generate correlated uniformly distributed random variables (depicted in the chart labeled “(b) Copula samples”). The correlated variables may then be transformed to the desired distribution by using univariate marginal flows [symbol] x (depicted in the chart labeled “(c) Joint distribution”).

With continued reference to FIG. 7, the inverse function used to generate synthetic data may be described as a flow function [symbol] x≈F_{X}⁽⁻¹⁾ that transforms a uniform random variable U into X˜F_{X}. The (quasi)-inverse function may be interpreted as a normalizing flow that transforms a uniform density into the one described by the copula distribution function C, which may be referred to herein as copula flow.

Normalizing flows are compositions of smooth, invertible mappings that transform one density into another. The approximation in [symbol] x≈F_{X}⁽⁻¹⁾ indicates that a (quasi) inverse distribution function is being estimated by using a flow function [symbol] x. If the true CDF F_{X} is learned, then

$${F}_{X} ( x ) = {ℱ}_{X}^{- 1} ( x ) = 𝓊 , 𝓊 ∼ Uniform [ 0 , 1 ] , ∀ x ∈ dom ( {F}_{x} ) \qquad$$

may be true, due to uniqueness of the CDF. An advantage of the normalizing flow formulation is that arbitrarily complex maps may be constructed as long as they are invertible and differentiable.

Consider an invertible flow function [symbol] : [symbol] ^{D}→ [symbol] ^{D}, which transforms a random variable as X= [symbol] (U). By using the change of variables formula, the density f_{X} of variable X is obtained as

$${f}_{X} ( X ) = fu ( {ℱ}^{- 1} ( X ) ) \vert det \frac{6 {ℱ}^{- 1} ( X )}{\partial X} ) \vert = \vert det \frac{6 {ℱ}^{- 1} ( X )}{\partial X} ) \vert , \qquad$$

where f_{U}( [symbol] ⁻¹(X))=f_{U}(U)=1.0, since f_{U}=Uniform [0, 1].

For the copula flow model, it may be assumed that the copula density c of the copula CDF C exists. Starting with the bivariate case for random variables X, Y, the density f_{XY} may be computed via the partial derivatives of the C, i.e.,

$${f}_{X Y} = \frac{{\partial }^{2} C ( {F}_{X} , {F}_{Y} )}{\partial {F}_{X} \partial {F}_{Y}} = {c}_{X Y} ( {F}_{X} , {F}_{Y} ) {f}_{X} {f}_{Y} .$$

This result may be generalized to the joint density f_{X}(X) of a d-dimensional random vector X=[X₁, . . . , X_{d}] as

$${f}_{X} = \underbrace{C x ( {F}_{{X}_{1}} , … , {F}_{{X}_{d}} )}_{copula density} \underbrace{{\prod }_{k = 1}^{d} {f}_{{X}_{k}}}_{marginal density} .$$

To construct the copula-based flow model, the joint density f_{X} above may be rewritten in terms of marginal flows [symbol] and the joint copula flow C_{X}. Then

$${f}_{X} ( X ) = \vert det ( \frac{\partial {C}_{X}^{- 1} ( {U}_{X} )}{\partial {U}_{X}} ) \vert {\prod }_{k = 1}^{d} \vert \frac{\partial {F}_{{X}_{k}}^{- 1} ( {X}_{k} )}{\partial {X}_{k}} \vert \qquad$$

is obtained, where C_{X} is the copula flow function and [symbol] _{X}_{₁}, . . . , [symbol] _{X}_{_{d}}. are marginal flow functions.

In accordance with embodiments, the flow-based likelihood may be derived by starting from the generative procedure for the samples. A d-dimensional independently distributed random vector U˜Uniform [0, 1]^{d} may be mapped through the copula flow C_{X} to obtain the random vector U_{X}=C_{X}(U). The joint vector is then mapped through the marginal flows [symbol] _{X} to obtain a random vector X= [symbol] _{X}(U_{X}). The combined formulation can be written as a composition of two flows to obtain X= [symbol] _{X}(C_{X}(U)), which is also a valid flow function.

The likelihood for this flow function can be written as

$${f}_{X} ( X ) = {f}_{{U}_{X}} ( {ℱ}_{X}^{- 1} ( X ) ) \vert det ( \frac{\partial {ℱ}_{X}^{- 1} ( X )}{\partial X} ) \vert . \qquad$$

The marginal flows are independent for each dimension of the random vector X. Hence, the determinant can be expressed as a product of the diagonal terms to obtain the likelihood

$${f}_{X} ( X ) = {f}_{{U}_{X}} ( {ℱ}_{X}^{- 1} ( X ) ) {\prod }_{i = 1}^{d} \vert ( \frac{\partial {ℱ}_{{X}_{i}}^{- 1} ( {x}_{i} )}{{\partial }_{{x}_{i}}} ) \vert . \qquad$$

The quantity f_{U}_{_{X}}( [symbol] _{X}⁻¹(X)) may essentially be the flow likelihood for the copula density, which can be written as

$${f}_{X} ( X ) = {f}_{{U}_{X}} ( {ℱ}_{X}^{- 1} ( X ) ) \vert det ( \frac{\partial {ℱ}_{X}^{- 1} ( X )}{\partial X} ) \vert = {f}_{U} ( {C}_{X}^{- 1} ( {U}_{X} ) ) \vert det ( \frac{\partial {C}_{X}^{- 1} ( {U}_{X} )}{\partial {U}_{X}} ) \vert = \vert det ( \frac{\partial {C}_{X}^{- 1} ( {U}_{X} )}{\partial {U}_{X}} ) \vert , \qquad$$

where f_{U}(C_{X}⁻¹U_{X})=f_{U}(U)=1.0, since f_{U}=Uniform [0, 1]. In accordance with embodiments, then, using the copula likelihood, as described above, in the total likelihood, as also described above, yields

$${f}_{X} ( X ) = \vert det ( \frac{\partial {𝒞}_{X}^{- 1} ( {ℱ}_{X}^{- 1} ( X ) )}{\partial {ℱ}_{X}^{- 1} ( X )} ) \vert {\prod }_{i = 1}^{d} \vert ( \frac{\partial {ℱ}_{{X}_{i}}^{- 1} ( {X}_{i} )}{\partial {ℱ}_{i}} ) \vert . \qquad$$

As discussed herein, the inverse of the flow function may be interpreted as a CDF:

$$X = {ℱ}_{X} ( {𝒞}_{X} ( U ) ) , \\ {𝒞}_{X}^{- 1} ( {ℱ}_{X}^{- 1} ( X ) ) = U . \qquad$$

If the flow function is replaced with the true marginal CDF [symbol] _{X} and the true copula CDF [symbol] _{X}, it may be rewritten as

$${H}_{X} ( X ) = {𝒞}_{X} ( {ℱ}_{X} ( X ) ) . \qquad$$

It is noted that this result is reached by starting from the normalizing flow formulation.

Even though the copula itself is defined on independent univariate marginals functions, X may be used in the notation to emphasize that these univariates are obtained by inverting the flow U_{X}_{ₖ}= [symbol] _{X}_{ₖ}⁻¹(Xₖ) for marginals.

Given a dataset {x₁, . . . , x_{N}} of size N, the flow may be trained by maximizing the total log-likelihood [symbol] =log f_{X}(x)=Σₙ₌₁^{N} log f_{X}(xₙ) with respect to the parametrization of flow function [symbol] . The log-likelihood may be written as the sum of two terms, namely

$$ℒ = {ℒ}_{{C}_{x}} + {ℒ}_{F} = {ℒ}_{{C}_{x}} + {\sum }_{k = 1}^{d} {ℒ}_{{X}_{k}} .$$

The copula flow log-likelihood [symbol] _{C}_{ₓ} depends on the marginal flows. Hence, the marginal flows may be trained first and then the copula flow. The gradients of both log-likelihood terms are independent as they are separable. The procedure of first training the marginals before fitting copula models may yield better performance and numerical stability.

In accordance with embodiments, copula is a CDF defined over uniform marginals, i.e., Uniform [0, 1]^{d}→Uniform [0, 1]. The inverse of this CDF may be used to generate samples via inverse transform sampling. For the multivariate case the conditional generation procedure may be used. Let U_{X}=[U_{X}_{₁}, . . . , U_{X}_{_{d}}] be a random vector with copula C_{X}, and U=U1, . . . , U_{d} be i.i.d. Uniform [0, 1] random variables. Then the multivariate flow transform U_{X}:=C_{X}(U) can be defined recursively as

$${U}_{{X}_{1}} := {C}_{{X}_{1}} ( {U}_{1} ) , {U}_{{X}_{k}} := {C}_{{X}_{k \vert \vert 1 , … , k - 1}} ( {U}_{k} \vert {U}_{{X}_{1} , … , {X}_{k - 1}} ) , 2 \leq k \leq d ,$$

where C_{X}_{_{k|1, . . . , k−1}}=C_{X}_{_{k|1, . . . , k−1}}⁻¹ is the flow function conditioned on all the variables U_{X}_{₁}, . . . , U_{X}_{_{k−1}}.

A significant concept is the interpretation of the inverse of the (normalizing) copula flow C_{X}⁻¹ as a conditional CDF. Moreover, it may be estimated C_{X}_{_{k|1, . . . , k−1}} recursively, with one dimension at a time, via a neural spline network. The conditioning variables, X₁, . . . Xₖ₋₁ are input to the network that outputs spline parameters for the flow C_{X}_{_{k|1, . . . , k−1}}. Similar to Masked Autoregressive Flow (MAF) such multiple flows may be stacked to create flexible multivariate copula flow C_{X}. This multivariate extension may be convenient for Archimedean copulas, where the generators for such copulas may be interpreted as conditional flow functions.

To estimate univariate marginals, both parametric and non-parametric density estimation methods may be used. However, for training the copula, models may be used that can be inverted easily to obtain uniform marginals, i.e., a well-defined CDF for the methods we employ for the density estimation is desirable. Further, a model that can be used for generating data via inverse transform sampling is desirable. In accordance with embodiments, monotone rational quadratic splines, neural spline flows (NSF) may be used. With a sufficiently dense spline, i.e., a large number of knot positions, arbitrarily complex marginal distributions can be learned. During such learning, the quasi-inverse function [symbol] :Uniform [0, 1]→ran(F), where F is the true CDF, a single parameter vector θd=[θ_{d}^{w}, θ_{d}^{h}, θ_{d}⁸] describing the width, height and slope parameters, respectively, may be sufficient. The details of a proposed spline network are discussed, below.

In accordance with embodiments, the interpretation of normalizing flow functions as a quantile function transforming a uniform density to the desired density via inverse transform sampling is a key point. As quantile functions are monotonic, rational quadratic splines (as described herein) are used as a normalizing flow function. However, changes are made to the original splines. These changes ensure that the flow is learning quantile function.

For instance, the univariate flow [symbol] maps from the Uniform [0, 1] to ran ( [symbol] _{X}) of the random variable X. Hence, the splines are asymmetric in their support. The standard spline network may be modified to build a map as (0, 1)→(B_{lower}, Bᵤₚₚₑᵣ) where B is the range of the marginal Infinite support can be added with B→∞. The knot positions are not parameterized by a neural network; rather they are treated as a free vector, i.e., θ_{d}=[θ_{d}^{w}, θ_{d}^{h}, θ_{d}^{s}] are the width, height and slope parameters, respectively, that characterize the flow function for the independent marginals of data dimension [symbol] _{θ}_{_{d}}. Out-of-bound values may be mapped back into the range and the gradients of the flow map may be set to 0 at these locations.

In accordance with embodiments, for copula flow, the same network as autoregressive neural spline flows (as described herein) may be used. As copula is a CDF defined over uniform densities, the copula flow spline maps Uniform [0, 1] Uniform [0, 1]. Apart from the change in the range of the splines, the copula flow architecture is the same as that of autoregressive neural spline flows.

Modelling mixed variables via normalizing flows can be challenging. Discrete data poses challenges for both copula learning as well as learning flow functions. For marginals, i.e., univariate flow functions, the input is a uniform distribution continuous in [0, 1], whereas the output is discrete and hence discontinuous. For copula learning, uniform marginals for the given training data are needed. With discrete inputs to the inverse flow function (CDF), the output is discontinuous in [0, 1].

In accordance with embodiments, learning the univariate flow maps, i.e., marginal learning, may be a first focus. Ordinal variables have a natural order, which we can use directly. For categorical data, each class may be assigned a unique integer in {0, . . . , n−1}, where n is the number of classes. A CDF may be defined over these integer values. As this assignment is not unique, the same category assignment may be maintained for training and data generation.

For discrete data generation, the data output of the flow function may be rounded to the next higher integer, i.e., random variable Y=ceil(X) may be considered. However, this procedure may not yield a valid density. To ensure that the samples are properly discretized, quantized distribution may be used, so that density learning can be formulated as a quantile learning procedure.

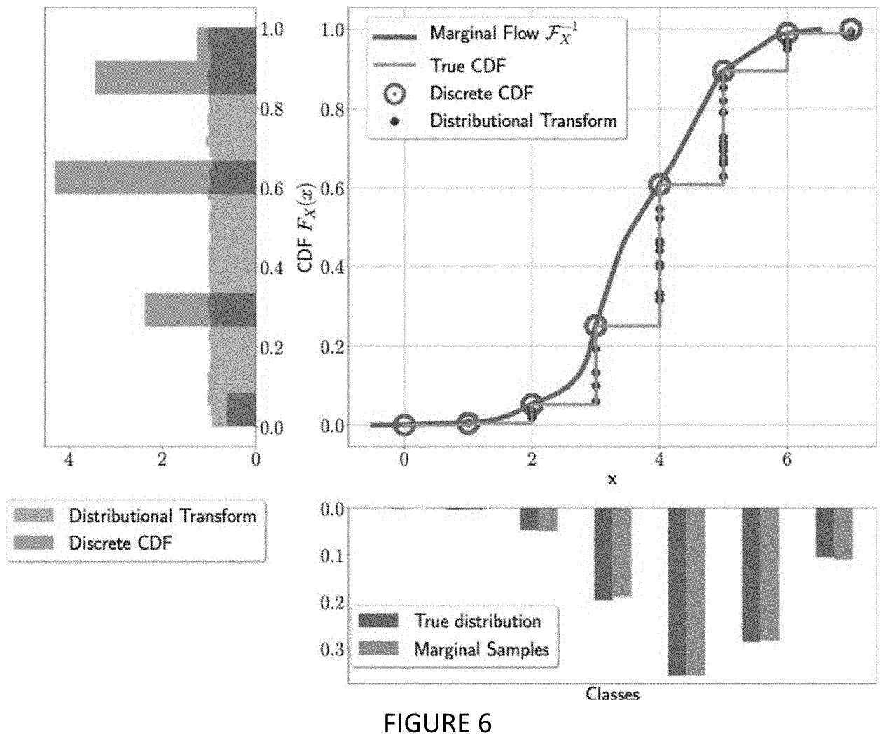

FIG. 6 illustrates discrete marginal flow, in accordance with embodiments. Shown in FIG. 6 is a discrete marginal flow for three discrete classes. The marginal flow gives discrete samples when rounded up. The distributional transform is uniform along the vertical line of the true CDF. The distributional transforms on the leftmost component of FIG. 6 looks similar to a uniform distribution of an embodiment. The towers show what it would have looked like without the use of distributional transform. The bottom component of FIG. 6 shows that the discrete data generated looks close to true data, e.g., it has a similar distribution.

In accordance with embodiments, a quantile range for a given class or ordinal integer may be assigned. The same spline-based flow functions as the one used for continuous marginals may be used, but with quantization as, e.g., the last step. An advantage of this discrete flow is that the quasi-inverse, i.e., the flow function is a continuous and monotonic function, which can be trained by maximizing the likelihood. FIG. 6 shows the spline-based flow function learned for a hypergeometric distribution, in accordance with embodiments. The continuous flow function in FIG. 6 learned for the discrete marginal function in FIG. 6, allows the generation of discrete data via inverse transform sampling.

However, the inverse of this flow function, i.e., the CDF of the marginal, results in discontinuous values at the locations of the training inputs (i.e., the circles in FIG. 6). Copulas are unique and well defined only for continuous univariate marginals. An exemplary way to find continuous univariate marginals for the discrete variable is via the distributional transform.

In accordance with embodiments, a definition of Distributional Transform may be as follows:

```
Let X ~ F_{X}. The modified CDF is defined as
    FX (x,v):= Pr(X < x) + v Pr(X = x).
Let V be uniformly distributed independent of X. Then the
distributional transform X → U of X is
  u := [symbol]    _{X}⁻¹ = [symbol]    _{X}_(x) + v ( [symbol]   _{X}(x) − [symbol]    _{X}_(x)),
Where [symbol]
    _{X}_{ₓ} = Pr(X < x), F_{X}(x) = Pr(X ≤ x)
and
      Pr(X = x) = F_{X}(x) − F_(x).
Accordingly, U ~ Uniform [0,1] and X = [symbol]    _{X}(U).
```

This distributional transform behaves similar to the probability integral transform for continuous distributions, i.e., a discrete random variable X mapped through the distributional transform gives a uniform marginal. However, unlike for continuous variables, the distributional map is stochastic and hence not unique. With the distributional transform, the copula model does not need a special treatment for discrete variables. This distributional transform definition may be used as a distributional transform for discrete data.

In FIG. 6, the cross marks show the values from distributional transform—all samples along the y axis that share a same x value. With the distributional transform and marginal splines, the copula flow model leverages normalizing flows to learn arbitrarily complex distributions.

Moreover, it can be shown that a copula flow is a universal density approximator. Accordingly, a model may be trained to generate any type of data, discrete or continuous, with the proposed copula flow model. This property holds true when the flow network converges to the inverse function.

Learning the probabilistic model for a dataset data is equivalent to estimating the density of the data. Based on the copula theory, the density estimation task may be divided into two parts—estimating univariate marginals and estimating the multivariate copula density over the univariate marginals. Normalizing flows may be used to learn both the copula density and univariate marginals.

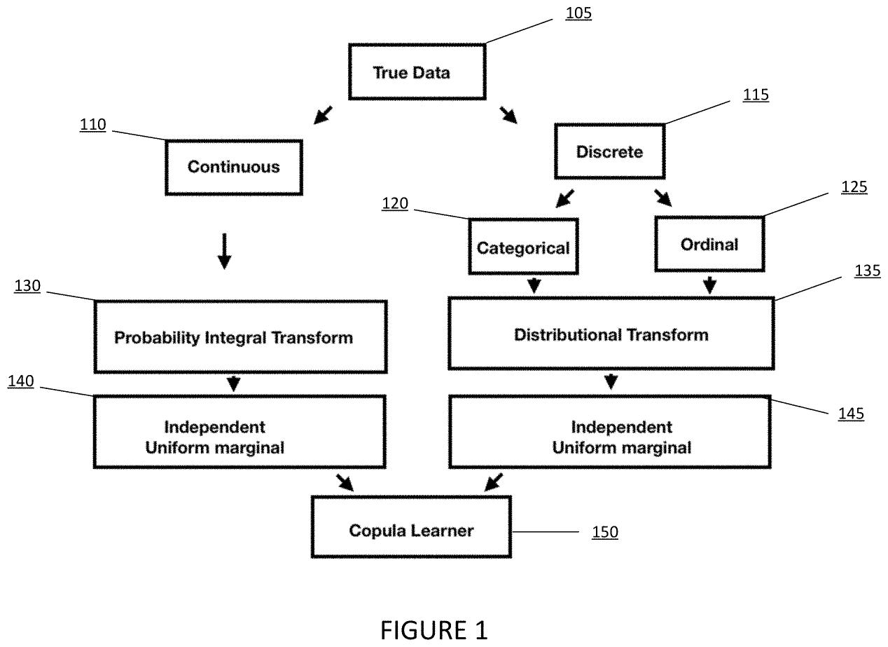

Referring to FIG. 1, an exemplary process flow for learning distributions for true data is provided according to embodiments. In the figure, a dataset of true 105 data may be received by, or accessible to, a processing apparatus (as is further described herein). As used herein, true data refers to real, or actual, data and may include actual personal details and/or personally identifiable information (PII) of real individuals. The true data may be separated into continuous data, as represented by block 110, and discrete data as represented by block 115. The discrete data may be further separated into categorical discrete data as represented by block 120 or ordinal discrete data as represented by block 125.

In accordance with embodiments, the continuous data may undergo a probability integral transform, as shown in block 130. The categorical and ordinal discrete data may both undergo a distributional transform as shown in block 135. An independent uniform marginal based on the probability transform of the discrete data may then be produced at block 140. Likewise, an independent uniform marginal based on the distributional transform of the discrete data may be produced at block 145. The independent marginals based on the transformed continuous data and the transformed discrete data may then be provided to a copula learner, such as shown in block 150.

In embodiments, the probability integral transform, the distributional transform, and the copula learner may be trained using normalizing flow methods.

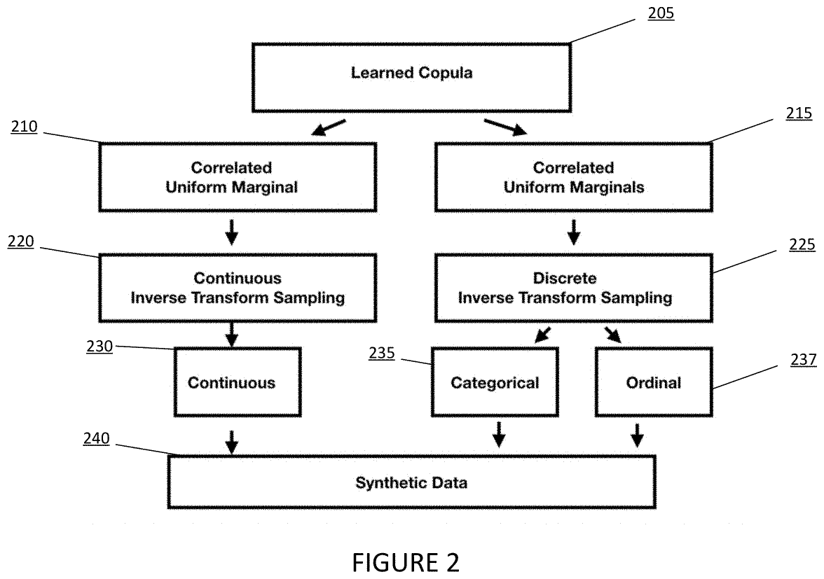

With reference to FIG. 2, once the distribution of the true data is learned, a learned copula model may be generated, as depicted at block 205, correlated uniform marginals may be generated for the continuous data at block 210 and for the discrete data at block 215. Continuous inverse transform sampling, at block 220, may be used to generate synthetic continuous data at block 230. Likewise, discrete inverse transform sampling, at block 225, may be used to generate synthetic discrete categorical data at block 235 and synthetic discrete ordinal data at block 237. The combined synthetic continuous data, synthetic discrete categorical data, and synthetic discrete ordinal data represent the generated synthetic data set 240 generated from the input true data set (block 105 of FIG. 1).

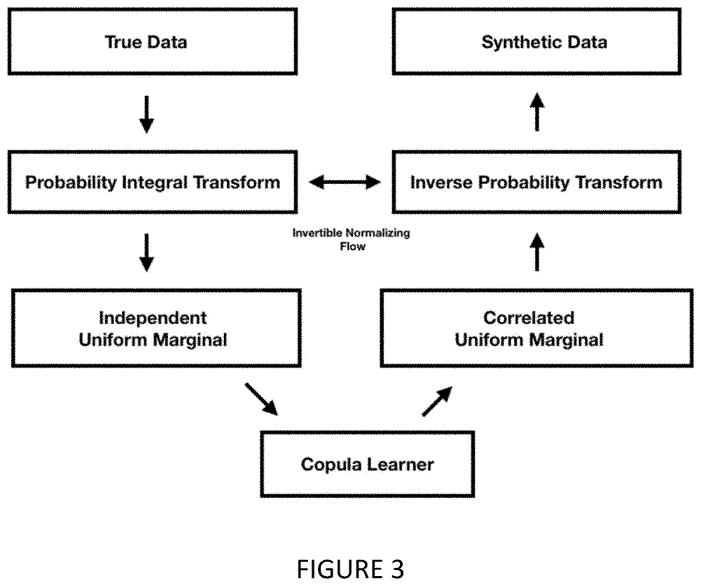

Referring to FIG. 3, an example of a continuous-data copula flow is provided, in accordance with embodiments. In FIG. 3, an invertible normalizing flow is depicted. Specifically, normalizing flows of continuous data may be the inverses of each other. FIG. 3 shows that this standard is true for continuous data.

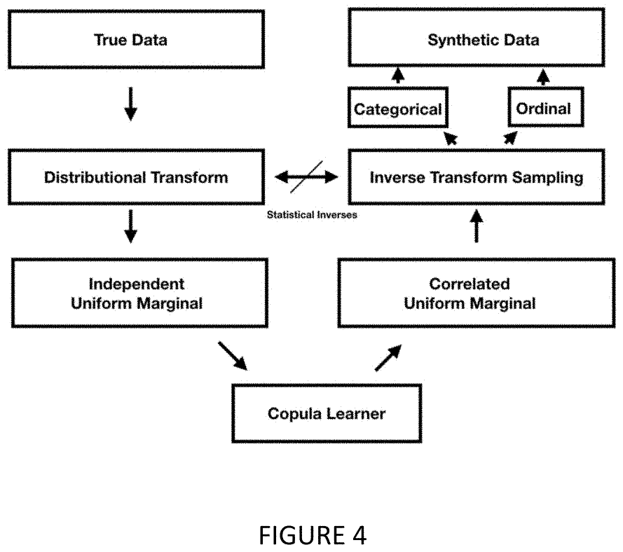

With reference to FIG. 4, an example of a discrete-data copula flow is provided, in accordance with embodiments. As shown in FIG. 4, normalizing flows of discrete data (either categorical or ordinal) are not required to be the inverses of each other. Embodiments, however, provide a similar pathway for discrete data, such as in FIG. 4, for typical methods such as those depicted in FIG. 3.

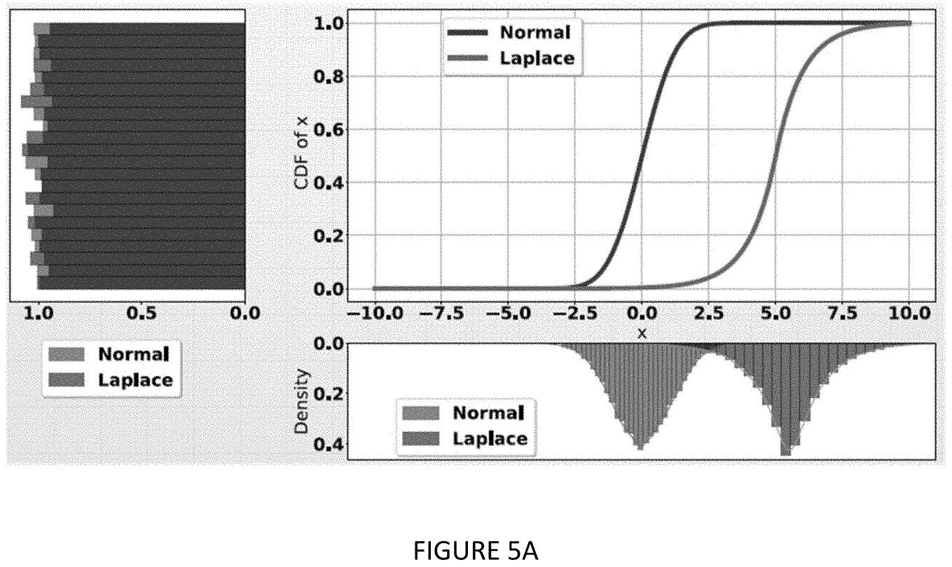

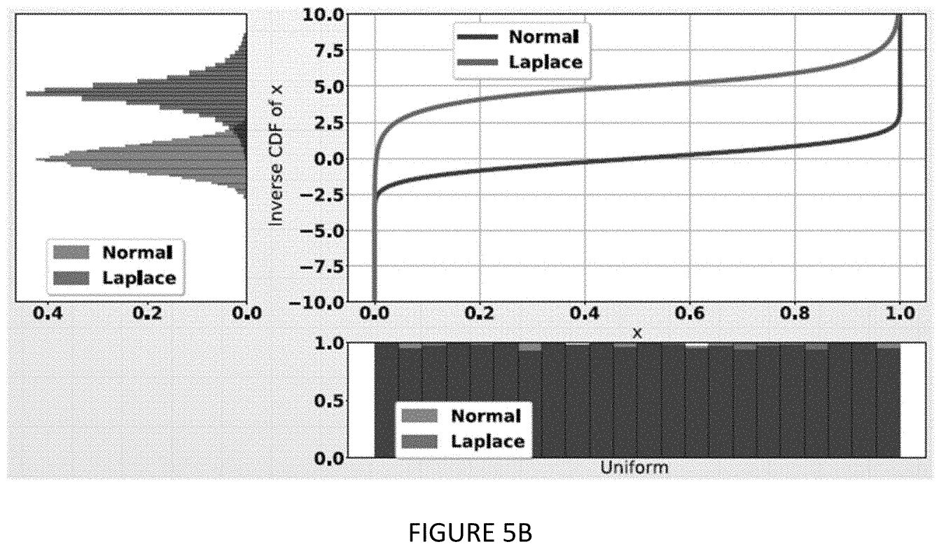

FIG. 5A illustrates a plot of a probability integral transform according to an embodiment, and FIG. 5B illustrates a quantile transform (e.g., an inverse CDF) according to an embodiment.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for generating synthetic data using a learned copula function, comprising:
receiving a true dataset on which to model synthetic data, wherein the true data comprises continuous true data and discrete true data;
applying, to the continuous true data, a probability integral transform and performing an independent uniform marginal;
applying, to the discrete true data, a distributional transform and performing an independent uniform marginal;
applying a copula learner to learn a copula from the transformed continuous true data and the transformed discrete true data;
identifying a first correlated uniform marginal from the learned copula based on the transformed continuous true data;
identifying a second correlated uniform marginal from the learned copula based on the transformed discrete true data;
applying continuous inverse transform sampling on the first correlated uniform marginal;
applying discrete inverse transform sampling on the second correlated uniform marginal; and
generating the synthetic data using the continuous inverse transform sampling and the discrete inverse transform sampling.

2. The method of claim 1, further comprising:
using a normalizing flow to learn the copula function.

3. The method of claim 2, further comprising:
using an autoregressive density network with the normalizing flow.

4. The method of claim 3, wherein the autoregressive density network comprises a masked autoregressive network.

5. The method of claim 1, further comprising:
learning a functional relationship within the continuous true data.

6. A method for generating synthetic data using a learned copula function, comprising:
receiving true data on which to model synthetic data, wherein the true data comprises discrete true data;
applying a distributional transform and performing an independent uniform marginal;
applying a copula learner to learn a copula from the transformed discrete true data;
identifying a correlated uniform marginal from the learned copula;
applying discrete inverse transform sampling on the correlated uniform marginal; and
generating the synthetic data using the discrete inverse transform sampling.

7. The method of claim 6, further comprising:
using a normalizing flow to learn the copula function.

8. The method of claim 7, further comprising:
using an autoregressive density network with the normalizing flow.

9. The method of claim 8, wherein the autoregressive density network comprises a masked autoregressive network.

10. A method for generating synthetic data using a learned copula function, comprising:
receiving a true dataset on which to model synthetic data, wherein the true data comprises continuous true data;
applying a probability integral transform and performing an independent uniform marginal;
applying a copula learner to learn a copula from the transformed continuous true data;
identifying a correlated uniform marginal from the learned copula;
applying continuous inverse transform sampling on the correlated uniform marginal; and
generating the synthetic data using the continuous inverse transform sampling.

11. The method of claim 10, further comprising:
using a normalizing flow to learn the copula function.

12. The method of claim 11, further comprising:
using an autoregressive density network with the normalizing flow.

13. The method of claim 12, wherein the autoregressive density network comprises a masked autoregressive network.

14. The method of claim 10, further comprising:
learning a functional relationship within the continuous true data.
